(19) United States
(12) Patent Application Publication
(10) Pub. No.: US 2026/0112536 A1
(43) Pub. Date: Apr. 23, 2026

(54) COIL ELECTRONIC COMPONENT

(71) Applicant: SAMSUNG ELECTRO-MECHANICS CO., LTD., Suwon-si (KR)

(72) Inventors: Sangjin Kim, Suwon-si (KR); Han Lee, Suwon-si (KR); Jongwook Lee, Suwon-si (KR); Boumseock Kim, Suwon-si (KR)

(73) Assignee: SAMSUNG ELECTRO-MECHANICS CO., LTD., Suwon-si (KR)

(21) Appl. No.: 19/084,423

(22) Filed: Mar. 19, 2025

(30) Foreign Application Priority Data
Oct. 21, 2024 (KR) 10-2024-0144039

(51) Int. Cl. H01F 27/30; H01F 27/28

(52) U.S. Cl. CPC H01F 27/306; H01F 27/2828

(57) ABSTRACT

A coil electronic component, including: a body including a magnetic material; three or more coils embedded in the body; a plurality of external electrodes disposed outside the body and connected to the coils; and gap portions disposed between the coils and having a different magnetic permeability than the body, wherein one of the gap portions has a different shape than the rest of the gap portions.

### CROSS-REFERENCE TO RELATED APPLICATION

This application claims priority to and the benefit of Korean Patent Application No. 10-2024-0144039, filed in the Korean Intellectual Property Office on Oct. 21, 2024, the entire contents of which are incorporated herein by reference.

### BACKGROUND

### (a) Technical Field

The present disclosure relates to a coil electronic component.

### (b) Description of the Related Art

An inductor, a type of coil electronic component, is a representative passive element that forms an electronic circuit, along with a resistor and a capacitor, to remove noise, and is combined with such a capacitor using electromagnetism to provide a resonance circuit amplifying a signal in a specific frequency band, a filter circuit, or the like.

Furthermore, power consumption is increasing as miniaturization and high performance of electronic devices are required. Due to this increase in power consumption, the switching frequency of power management integrated circuit (PMIC) or DC-DC converter used in the power circuit of electronic devices is becoming higher, the output current is increasing, and the use of power inductors used to stabilize the output current of PMIC or DC-DC converter is increasing.

Demand for an array-type inductor having the advantage of reducing a mounting area is also increasing. Array-type inductors include a plurality of coils disposed adjacent to each other, and it is necessary to reduce the inductance deviation between the coils.

### SUMMARY

One aspect of the embodiment attempts to provide a coil electronic component capable of reducing a capacitance variation between coils.

However, the problem to be solved by the present embodiments is not limited to the above-described problems, and can be variously extended within the scope of the technical spirit included in the present disclosure.

An embodiment provides a coil electronic component including: a body including a magnetic material; three or more coils embedded in the body, the three or more coils include a first coil, a second coil, and a third coil; a plurality of external electrodes disposed outside the body and connected to the three or more coils; and a plurality of gap portions including a first gap portion disposed between the first coil and the second coil, and a second gap portion disposed between the second coil and the third coil, the plurality of gap portions having a magnetic permeability different from a magnetic permeability of the body, wherein the first gap portion has a shape different from a shape of the second gap portion.

The three or more coils may further include a fourth coil, where the first coil, the second coil, the third coil, and the fourth coil are spaced apart from each other in a first direction, the plurality of gap portions may further include a third gap portion, where the first gap portion is disposed in a first region between the first coil and the second coil, the second gap portion is disposed in a second region between the second coil and the third coil, and the third gap portion is disposed in a third region between the third coil and the fourth coil, and the third gap portion may have a shape different from (i) the shape of the first gap portion or (ii) the shape of the second gap portion.

The first gap portion and the third gap portion may have the same shape, and the second gap portion may have a shape different from the same shape.

In a second direction intersecting the first direction, both the first gap portion and the third gap portion may be spaced apart from an outer surface of the body.

The coil electronic component may further include, in the second direction, a first margin region between the outer surface of the body and the first coil, a second margin region between the outer surface of the body and the second coil, a third margin region between the outer surface of the body and the third coil, and a fourth margin region between the outer surface of the body and the fourth coil, and a distance between the outer surface of the body and the first gap portion may be ⅓ of an average thickness of the first margin region and the second margin region, and a distance between the outer surface of the body and the third gap portion may be ⅓ of an average thickness of the third margin region and the fourth margin region.

In the second direction, the second gap portion may include a portion flush with the outer surface of the body.

In a second direction intersecting the first direction, the first gap portion and the third gap portion may each includes a portion flush with an outer surface of the body.

In the second direction, the second gap portion may be spaced apart from the outer surface of the body.

The coil electronic component may further include, in the second direction, a first margin region between the outer surface of the body and the first coil, a second margin region between the outer surface of the body and the second coil, a third margin region between the outer surface of the body and the third coil, and a fourth margin region between the outer surface of the body and the fourth coil, and a distance between the outer surface of the body and the second gap portion may be ⅓ of an average thickness of the second margin region and the third margin region.

The first region, the second region and the third region may have a first distance, a second distance, and a third distance, respectively, in the first direction, the first gap portion, the second gap portion and the third gap portion may have a first width, a second width and a third width, respectively, in the first direction, the first width may be greater than 24% and less than 42% of the first distance, the second width may be greater than 24% and less than 42% of the second distance, and the third width may be greater than 24% and less than 42% of the third distance.

The coil electronic component may further include a first support member, a second support member, a third support member and a fourth support member embedded in the body and spaced apart from each other, wherein the first coil may be disposed on the first support member, the second coil may be disposed on the second support member, the third coil may be disposed on the third support member, and the fourth coil may be disposed on the fourth support member.

The coil electronic component may further include a first via penetrating the first support member, a second via penetrating the second support member, a third via penetrating the third support member, and a fourth via penetrating the fourth support member, wherein the first coil may include a first coil pattern and a second coil pattern, the first coil pattern and the second coil pattern are disposed on a first surface and a second surface of the first support member, respectively, and connected to each other through the first via, the second coil may include a third coil pattern and a fourth coil pattern, the third coil pattern and the fourth coil pattern are disposed on a first surface and a second surface of the second support member, respectively, and connected to each other through the second via, the third coil may include a fifth coil pattern and a sixth coil pattern, the fifth coil pattern and the sixth coil pattern are disposed on a first surface and a second surface of the third support member, respectively, and connected to each other through the third via, and the fourth coil may include a seventh coil pattern and a eighth coil pattern, the seventh coil pattern and the eighth coil pattern are disposed on a first surface and a second surface of the fourth support member, respectively, and connected to each other through the fourth via.

The body may include a laminate that may include a stack of a plurality of magnetic sheets, and the first coil, the second coil, the third coil, and the fourth coil may each include a plurality of conductor patterns disposed on each magnetic sheet among the plurality of magnetic sheets and connected to each other.

Each of the first coil, the second coil, the third coil and the fourth coil may include at least one turn of a conductive wire.

The body may include a first core penetrating the first coil, a second core penetrating the second coil, a third core penetrating the third coil, and a fourth core penetrating the fourth coil.

The coil electronic component may further include an insulating layer disposed on the surface of the conductive wire.

A relative magnetic permeability of each of the first gap portion, the second gap portion, and the third gap portion may be 30 or more and 40 or less.

The first gap portion may be spaced apart from the second gap portion in a first direction, and in a second direction intersecting the first direction, the first gap portion may be spaced apart from an outer surface of the body, and the second gap portion may include a portion flush with the outer surface of the body.

The first gap portion may be disposed in a first region between the first coil and the second coil, the second gap portion may be disposed in a second region between the second coil and the third coil, the first region and the second region have a first distance and a second distance, respectively, in the first direction, the first gap portion and, the second gap portion have a first width and a second width, respectively, in the first direction, the first width may be greater than 24% and less than 42% of the first distance, and the second width may be greater than 24% and less than 42% of the second distance.

A relative magnetic permeability of each of the first gap portion and the second gap portion may be 30 or more and 40 or less.

According to the embodiment, it may be possible to provide a coil electronic component capable of reducing capacitance deviation between a plurality of coils disposed adjacent to each other.

### BRIEF DESCRIPTION OF THE DRAWINGS

FIG. 1 illustrates a schematic perspective view showing a coil electronic component according to an embodiment.

FIG. 2 illustrates a top plan view of FIG. 1.

FIG. 3 illustrates a schematic cross-sectional view taken along line I-I′ of FIG. 1.

FIG. 4 illustrates an enlarged view of a region A1 of FIG. 3.

FIG. 5 illustrates an enlarged view of a region B1 of FIG. 3.

FIG. 6 illustrates an enlarged view of a region C1 of FIG. 3.

FIG. 7 illustrates a schematic cross-sectional view showing a coil electronic component according to another embodiment.

FIG. 8 illustrates an enlarged view of a region A2 of FIG. 7.

FIG. 9 illustrates an enlarged view of a region B2 of FIG. 7.

FIG. 10 illustrates an enlarged view of a region C2 of FIG. 7.

FIG. 11 illustrates a schematic perspective view showing a coil electronic component according to another embodiment.

FIG. 12 illustrates a top plan view of FIG. 11.

FIG. 13 illustrates an exploded perspective view showing a body of the coil electronic component of FIG. 11.

FIG. 14 illustrates a schematic cross-sectional view taken along line II-II′ of FIG. 12.

FIG. 15 illustrates a schematic cross-sectional view showing a coil electronic component according to another embodiment.

FIG. 16 illustrates a schematic perspective view showing a coil electronic component according to another embodiment.

FIG. 17 illustrates a schematic cross-sectional view taken along line III-III′ of FIG. 16.

FIG. 18 illustrates a schematic cross-sectional view showing a coil electronic component according to another embodiment.

### DETAILED DESCRIPTION

Hereinafter, various embodiment of the present disclosure will be described in detail so that a person of ordinary skill in the technical field to which the present disclosure belongs can easily implement it with reference to the accompanying drawings. The drawings and description are to be regarded as illustrative in nature and not restrictive. Like reference numerals designate like elements throughout the specification. In addition, some components in the accompanying drawings are exaggerated, omitted, or schematically illustrated, and the size of each component does not fully reflect the actual size.

The accompanying drawings are provided only in order to allow embodiments disclosed in the present specification to be easily understood and are not to be interpreted as limiting the spirit disclosed in the present specification, and it is to be understood that the present invention includes all modifications, equivalents, and substitutions without departing from the scope and spirit of the present invention.

Terms including ordinal numbers such as first, second, and the like will be used only to describe various components, and are not to be interpreted as limiting these components. The terms are only used to differentiate one component from other components.

It will be understood that when an element such as a layer, film, region, or substrate is referred to as being “on” another element, it can be directly on the other element or intervening elements may also be present. In contrast, when an element is referred to as being “directly on” another element, there are no intervening elements present. Further, in the specification, the word “on” or “above” means disposed on or below the object portion, and does not necessarily mean disposed on the upper side of the object portion based on a gravitational direction.

It will be further understood that terms “comprises/includes” or “have” used throughout the specification specify the presence of stated features, numerals, steps, operations, components, parts, or a combination thereof, but do not preclude the presence or addition of one or more other features, numerals, steps, operations, components, parts, or a combination thereof. Accordingly, unless explicitly described to the contrary, the word “comprise” and variations such as “comprises” or “comprising” will be understood to imply the inclusion of stated components but not the exclusion of any other components.

Further, throughout the specification, the phrase “in a plan view” means when an object portion is viewed from above, and the phrase “in a cross-sectional view” means when a cross-section taken by vertically cutting an object portion is viewed from the side.

In addition, throughout the specification, “connected” means that two or more components are not only directly connected, but two or more components may be connected indirectly through other components, physically connected as well as being electrically connected, or it may be referred to by different names depending on the location or function, but may mean integral.

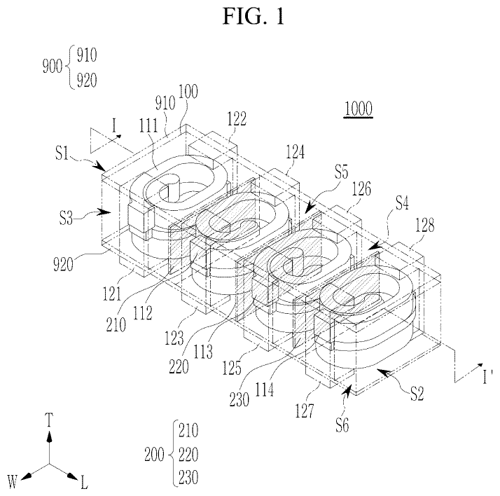

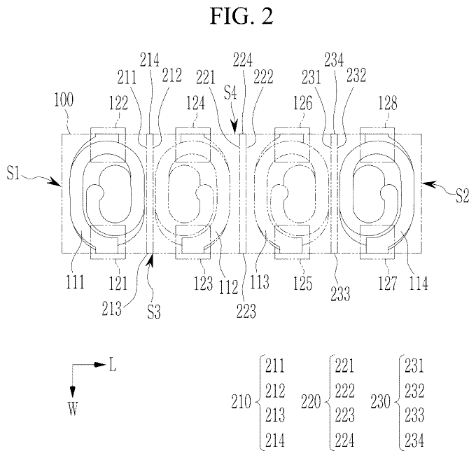

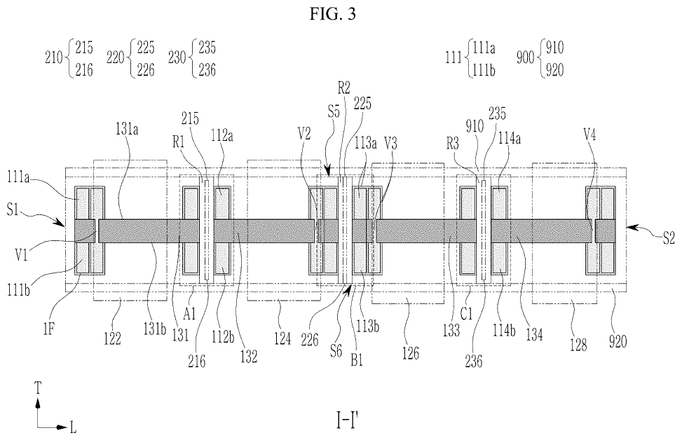

FIG. 1 illustrates a schematic perspective view showing a coil electronic component according to an embodiment, FIG. 2 illustrates a top plan view of FIG. 1, and FIG. 3 illustrates a schematic cross-sectional view taken along line I-I′ of FIG. 1.

Referring to FIGS. 1, 2, and 3, the coil electronic component 1000 according to an embodiment corresponds to an array-type inductor that includes a plurality of coils 111, 112, 113, and 114 spaced apart from each other.

The coil electronic component 1000 may include first to fourth coils 111, 112, 113, and 114, but the present embodiment is not limited thereto. For example, it may be possible to provide a coil electronic component that includes three coils or a coil electronic component that includes more than four coils, as needed.

The coil electronic component 1000 may include a body 100, a plurality of external electrodes 121, 122, 123, 124, 125, 126, 127, and 128 disposed on an outer surface of the body 100, a plurality of coils 111, 112, 113, and 114 embedded in the body 100, and a gap portion 200.

The body 100 may have a substantially rectangular hexahedral shape, but the present embodiment is not limited thereto. Due to shrinkage of magnetic powder, etc. during sintering, the body 100 may have a substantially rectangular parallelepiped shape, although it is not a perfect rectangular parallelepiped shape. For example, the body 100 has a substantially rectangular parallelepiped shape, but portions corresponding to corners or vertices may each have a rounded shape.

In the present embodiment, for better understanding and ease of description, two surfaces opposing each other in the length direction (L-axis direction, first direction) of the coil electronic component 1000 are defined as a first surface S1 and a second surface S2, respectively, two surfaces opposing each other in the width direction (W-axis direction, third direction) of the coil electronic component 1000 are defined as a third surface S3 and a fourth surface S4, respectively, and two surfaces opposing each other in the thickness direction (T-axis direction, second direction) of the coil electronic component 1000 are defined as a fifth surface S5 and a sixth surface S6, respectively.

A length of the coil electronic component 1000 may refer to, based on an optical microscope or scanning electron microscope (SEM) photograph of a cross-section taken along the length direction (L-axis direction)-thickness direction (T-axis direction) at a center of the coil electronic component 1000 in the width direction (W-axis direction), a maximum value among lengths of a plurality of line segments that connect two outermost boundary lines opposing each other in the length direction (L-axis direction) of the coil electronic component 1000 shown in the cross-sectional photograph described above and are parallel to the length direction (L-axis direction). Alternatively, the length of the coil electronic component 1000 may refer to a minimum value among lengths of a plurality of line segments that connect two outermost boundary lines opposing each other in the length direction (L-axis direction) of the coil electronic component 1000 shown in the cross-sectional photograph described above and are parallel to the length direction (L-axis direction). Alternatively, the length of the coil electronic component 1000 may indicate an arithmetic average value of the lengths of at least two line segments among a plurality of line segments that connect two outermost boundary lines opposing each other in the length direction (L-axis direction) of the coil electronic component 1000 shown in the cross-sectional photograph described above and are parallel to the length direction (L-axis direction).

A thickness of the coil electronic component 1000 may refer to, based on an optical microscope or scanning electron microscope (SEM) photograph of a cross-section taken along the length direction (L-axis direction)-thickness direction (T-axis direction) at a center of the coil electronic component 1000 in the width direction (W-axis direction), a maximum value among lengths of a plurality of line segments that connect two outermost boundary lines opposing each other in the thickness direction (T-axis direction) of the coil electronic component 1000 shown in the cross-sectional photograph described above and are parallel to the thickness direction (T-axis direction). Alternatively, the thickness of the coil electronic component 1000 may refer to a minimum value among lengths of a plurality of line segments that connect two outermost boundary lines opposing each other in the thickness direction (T-axis direction) of the coil electronic component 1000 illustrated in the cross-sectional photograph described above and are parallel to the thickness direction (T-axis direction). Alternatively, the thickness of the coil electronic component 1000 may refer to an arithmetic average value of the lengths of at least two line segments among a plurality of line segments that connect two outermost boundary lines opposing each other in the thickness direction (T-axis direction) of the coil electronic component 1000 illustrated in the cross-sectional photograph described above and are parallel to the thickness direction (T-axis direction).

A width of the coil electronic component 1000 may refer to, based on an optical microscope or scanning electron microscope (SEM) photograph of a cross-section taken along the length direction (L-axis direction)-width direction (W-axis direction) at a center of the coil electronic component 1000 in the thickness direction (T-axis direction), a maximum value among lengths of a plurality of line segments that connect two outermost boundary lines opposing each other in the width direction (W-axis direction) of the coil electronic component 1000 shown in the cross-sectional photograph described above and are parallel to the width direction (W-axis direction). Alternatively, the width of the coil electronic component 1000 may refer to a minimum value among lengths of a plurality of line segments that connect two outermost boundary lines opposing each other in the width direction (W-axis direction) of the coil electronic component 1000 shown in the cross-sectional photograph described above and are parallel to the width direction (W-axis direction). Alternatively, the width of the coil electronic component 1000 may refer to an arithmetic average value of the lengths of at least two line segments among a plurality of line segments that connect two outermost boundary lines opposing each other in the width direction (W-axis direction) of the coil electronic component 1000 shown in the cross-sectional photograph described above and are parallel to the width direction (W-axis direction).

Each of the length, width, and thickness of the coil electronic component 1000 may be measured by a micrometer measurement method. In the micrometer measurement method, a zero point is set with a micrometer providing repeatability and reproducibility (Gage R&R), the coil electronic component 1000 according to the present embodiment is inserted between tips of the micrometer, and a measuring lever of the micrometer is turned for the measurement. When measuring the length of the coil electronic component 1000 by the micrometer measurement method, the length of the coil electronic component 1000 may mean a value measured once or mean an arithmetic average of values measured a plurality of times. This may be equally applied to measuring the width and thickness of the coil electronic component 1000.

The body 100 may include a plurality of coils 111, 112, 113, and 114 spaced apart from each other in the length direction (L-axis direction) and a gap portion 200.

The coils 111, 112, 113, and 114 may have substantially the same shape. Here, the disclosure that the of coils has the same shape means that the line width, thickness, and number of windings of coil patterns of each coil are substantially the same. In FIG. 1 to FIG. 3, for better understanding and ease of description, the number of windings of the coil is represented by approximately 1.5 turns, but the present embodiment is not limited thereto, and may be appropriately selected by a person skilled in the art in consideration of electrical characteristics such as required inductance and direct current resistance (Rdc).

The body 100 constitutes an exterior of the coil electronic component 1000, and is a space where a magnetic path, which is a path through which the magnetic flux generated by the first to fourth coil 111, 112, 113, and 114 passes, is formed, when a current is applied to the first to fourth coil 111, 112, 113, and 114 through the plurality of external electrodes 121, 122, 123, 124, 125, 126, 127, and 128.

The body 100 may surround and encapsulate the first to fourth coils 111, 112, 113, and 114 and first to fourth support members 131, 132, 133, and 134, and may include a magnetic material. The body 100 may include magnetic particles, and an insulating material may be provided between the magnetic particles.

The magnetic material may include a first metal magnetic particle, a second metal magnetic particle having a smaller particle size than that of the first metal magnetic particle, and a third metal magnetic particle having a smaller particle size than that of the second metal magnetic particle. An average particle diameter (D50) of the first metal magnetic particle may be 5 μm or more and 30 μm or less, an average particle diameter (D50) of the second metal magnetic particle may be 1 μm or more and 5 μm or less, and an average particle diameter (D50) of the third metal magnetic particle may be 0.05 μm or more and 0.5 μm or less.

The magnetic particles may be ferrite particles or metal magnetic particles exhibiting magnetic characteristics.

The ferrite particles may include, for example, at least one of spinel-type ferrites such as Mg—Zn-based, Mn—Zn-based, Mn—Mg-based, Cu—Zn-based, Mg—Mn—Sr-based, Ni—Zn-based ferrites, hexagonal ferrites such as Ba—Zn-based, Ba—Mg-based, Ba—Ni-based, Ba—Co-based, Ba—Ni—Co-based ferrites, garnet-type ferrites such as Y-based ferrites and Li-based ferrite.

The metal magnetic particles may be composed of two or more types of powders having different compositions, and may include at least one selected from the group consisting of iron (Fe), silicon (Si), chromium (Cr), cobalt (Co), molybdenum (Mo), aluminum (Al), niobium (Nb), copper (Cu), and nickel (Ni). For example, metal magnetic particles may be at least one of pure iron, Fe—Si-based alloy, Fe—Si—Al-based alloy, Fe—Ni-based alloy, Fe—Ni—Mo-based alloy, Fe—Ni—Mo—Cu-based alloy, Fe—Co-based alloy, Fe—Ni—Co-based alloy, Fe—Cr-based alloy, Fe—Cr—Si-based alloy, Fe—Si—Cu—Nb-based alloy, Fe—Ni—Cr-based alloy, Fe—Cr—Al-based alloy. Here, different compositions of the metal magnetic particles may mean different contents.

The metal magnetic particles may be amorphous or crystalline. For example, the metal magnetic particles may be an Fe—Si—B—Cr amorphous alloy, but the present embodiment is not limited thereto. The metal magnetic particles may have an average particle diameter in a range from about 0.1 μm to 30 μm, but the embodiment is not limited thereto.

In the specification, the average particle size may mean a particle size distribution expressed by D₉₀, D₅₀, or the like. The particle size distribution is well known to those skilled in the art as an index indicating what size (particle diameter) particles are included in what proportion in a particle group to be measured. D₅₀ (a particle diameter corresponding to 50% of a cumulative volume of the particle size distribution) refers to an average particle diameter.

The metal magnetic particles may be two or more types of different metal magnetic particles. Herein, by different types of metal magnetic particles, it is meant that the metal magnetic particles are distinguished from each other in at least one of an average particle diameter, composition, component ratio, crystallinity, and shape.

The insulating material may include epoxy, polyimide, liquid crystal polymer, etc., alone or in combination, but the embodiment is not limited thereto.

The coils 111, 112, 113, and 114 may be embedded in the body 100 to exhibit the characteristics of the coil electronic component 1000. For example, when the coil electronic component 1000 of the present embodiment is used as a power inductor, when a current is applied to the coils 111, 112, 113, and 114, the coils may serve to stabilize the power supply of an electronic device by storing energy in the form of a magnetic field maintain an output voltage.

Starting with the first coil 111 closest to the first surface S1 of the body 100, the second coil 112, the third coil 113, and the fourth coil 114 may be sequentially disposed in the length direction (L-axis direction). Accordingly, the fourth coil 114 may be disposed closest to the second surface S2 of the body 100, and the second coil 112 and the third coil 113 may be disposed between the first coil 111 and the fourth coil 114.

The respective winding axes of the first coil 111, the second coil 112, the third coil 113, and the fourth coil 114 may be parallel to the thickness direction (T-axis direction) of the body 100.

The first coil 111 may be connected to the first external electrode 121 and the second external electrode 122, which are disposed to be spaced apart from each other in the width direction (W-axis direction) of the body 100, and the second coil 112 may be connected to the third external electrode 123 and the fourth external electrode 124, which are disposed to be spaced apart from each other in the width direction (W-axis direction) of the body 100.

The third coil 113 may be connected to the fifth external electrode 125 and the sixth external electrode 126, which are spaced apart from each other in the width direction (W-axis direction) of the body 100, and the fourth coil 114 may be connected to the seventh external electrode 127 and the eighth external electrode 128, which are spaced apart from each other in the width direction (W-axis direction) of the body 100.

The first to eighth external electrodes 121, 122, 123, 124, 125, 126, 127, and 128 may extend from the third surface S3 or the fourth surface S4 of the body 100 to cover a portion of the fifth surface S5 and a portion of the sixth surface S6, but the present embodiment is not limited thereto. For example, the first to eighth external electrodes 121, 122, 123, 124, 125, 126, 127, and 128 may be disposed only on the third surface S3 or the fourth surface S4 of the body 100, or may extend from the third surface S3 or the fourth surface S4 to cover a portion of the sixth surface S6.

For example, the first to eighth external electrodes 121, 122, 123, 124, 125, 126, 127, and 128 may include a conductive material such as copper (Cu), aluminum (Al), silver (Ag), tin (Sn), gold (Au), nickel (Ni), lead (Pb), chromium (Cr), titanium (Ti), or an alloy thereof, but the embodiment not limited thereto.

As another example, the first to eighth external electrodes 121, 122, 123, 124, 125, 126, 127, and 128 may include a metal and glass. The metal may be, for example, a conductive metal including copper (Cu), nickel (Ni), tin (Sn), palladium (Pd), platinum (Pt), gold (Au), silver (Ag), tungsten (W), titanium (Ti), lead (Pb), or an alloy thereof. The glass component included in the external electrode may be a mixture of oxides. The glass component may include, for example, a silicon oxide, a boron oxide, an aluminum oxide, a transition metal oxide, an alkali metal oxide, an alkaline-earth metal oxide, or a combination thereof. Herein, the transition metal may be selected from zinc (Zn), titanium (Ti), copper (Cu), vanadium (V), manganese (Mn), iron (Fe), or nickel (Ni), the alkali metal may be selected from lithium (Li), sodium (Na), or potassium (K), and the alkaline-earth metal may be selected from magnesium (Mg), calcium (Ca), strontium (Sr), or barium (Ba). The method of forming the external electrode may not be particularly limited. For example, it may be formed by dipping a body in a conductive paste containing a conductive metal and glass, or by printing a conductive paste on a surface of the body by, e.g., screen printing or gravure printing method. Furthermore, various methods, such as applying a conductive paste on the surface of a body or transferring a dry film formed by drying a conductive paste to a body, may be used.

Referring to FIG. 3, the first coil 111 may be disposed on a first support member 131. The first coil 111 may include an upper coil 111a disposed on an upper surface 131a of the first support member 131 and a lower coil 111b disposed on a lower surface 131b of the first support member 131. The upper coil 111a and the lower coil 111b may be connected to each other through a first via V1 penetrating the first support member 131.

The first support member 131 may be made of an insulating material including a thermosetting insulating resin such as an epoxy resin, a thermoplastic insulating resin such as a polyimide, or a photosensitive insulating resin, or may be formed by impregnating a reinforcing material such as glass fiber or inorganic filler in the insulating resin. For example, the support member may be made of an insulating material such as Prepreg, ABF (Ajinomoto Build-up Film), FR-4, BT (Bismaleimide Triazine) film, or PID (Photo Imageable Dielectric) film, but the present embodiment is not limited thereto.

At least one selected from the group consisting of silica (SiO₂), alumina (Al₂O₃), silicon carbide (SiC), barium sulfate (BaSO₄), talc, clay, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃) may be used as the inorganic filler.

Each of the first coil 111 and the first via V1 may be made of a conductive material such as copper (Cu), aluminum (Al), silver (Ag), tin (Sn), gold (Au), nickel (Ni), lead (Pb), titanium (Ti), or an alloy thereof, but the present embodiment is not limited thereto.

An insulating layer IF may be disposed between the first coil 111 and the body 100. The insulating layer IF may formed along the surface of the first support member 131 and the surface of the first coil 111. There may be no insulating layer IF at a portion where the first support member 131 and the first coil 111 are connected to the first external electrode 121 and the second external electrode 122. The insulating layer IF is for insulating the first coil 111 from the body 100, and may include a known insulating material such as parylene. Any insulating material may be used in the insulating layer IF, and there is no particular limitation. For example, the insulating layer IF may be a polyurethane resin, a polyester resin, an epoxy resin, or a polyamideimide resin. The insulating layer IF may be formed by a method such as vapor deposition, but the present embodiment is not limited thereto. For example, the insulating layer IF may be formed by stacking insulating layers on both surfaces of the first support member 131.

The second coil 112, the third coil 113, and the fourth coil 114 differ from the first coil 111 only in their locations, so redundant descriptions thereof will be omitted.

Meanwhile, a surface insulating layer 900 may be disposed on the fifth surface S5 and the sixth surface S6 of the body 100.

The surface insulating layer 900 may include a first insulating layer 910 and a second insulating layer 920. The first insulating layer 910 may be disposed on the fifth surface S5 of the body 100, and the second insulating layer 920 may be disposed on the sixth surface S6 of the body 100.

The surface insulating layer 900 may partially cover the fifth surface S5 and the sixth surface S6 of the body 100. That is, the first to eighth external electrodes 121, 122, 123, 124, 125, 126, 127, and 128 may be disposed on the fifth surface S5 and the sixth surface S6 of the body 100, and the surface insulating layer 900 may not cover the first to eighth external electrodes 121, 122, 123, 124, 125, 126, 127, and 128.

In other embodiments, the surface insulating layer 900 may also be disposed on at least one of the first surface S1, the second surface S2, the third surface S3, or the fourth surface S4 of the body 100.

The surface insulating layer 900 may prevent current leakage between the first to eighth external electrodes 121, 122, 123, 124, 125, 126, 127, and 128.

For example, the surface insulating layer 900 may include a thermoplastic resin such as a polystyrene-based resin, a vinyl acetate-based resin, a polyester-based resin, a polyethylene-based resin, a polypropylene-based resin, a polyamide-based resin, a rubber-based resin, an acrylic-based resin, and the like, a thermosetting resin such as a phenol-based resin, an epoxy-based resin, a urethane-based resin, a melamine-based resin, an alkyd-based resin, a photosensitive resin, parylene, SiOₓ, or SiNₓ.

The surface insulating layer 900 may be formed through a process such as screen printing, pad printing, dipping, spray printing, or the like. For example, the surface insulating layer 900 may be formed by applying a liquid insulating resin to a surface of the body 100, or by stacking an insulating film such as a dry film on the surface of the body 100, or through a thin film process such as vapor deposition. In the case where the surface insulating layer 900 is formed of an insulating film, the insulating film may be an ABF (Ajinomoto Build-up Film) or a polyimide film, etc., which do not include a photosensitive insulating resin.

When four coils are disposed in an array structure as in the present embodiment, interference may occur between the coils, changing the inductance characteristics of the coil electronic component.

Because the second coil 112 and the third coil 113 are disposed between the first coil 111 and the fourth coil 114, the inductance of the second coil and the third coil may significantly increase under the influence of the magnetic flux generated by the first coil 111 and the fourth coil 114. In this case, the inductance deviation between the coils may increase. As the inductance deviation increases, that is, as the deviation of the coefficient of coupling increases, leakage inductance exists, which may affect the resonance frequency and thus may cause difficulties in a circuit design.

According to the present embodiment, the inductance deviation may be reduced by disposing a gap portion 200 having a magnetic permeability greater than that of the body 100 between the coils 111, 112, 113, and 114. That is, the gap portion 200 includes a magnetic material like the body 100, but may have a magnetic permeability that is greater than the magnetic permeability of the body 100.

For example, a relative magnetic permeability of the body 100 may be 12, and a relative magnetic permeability of the gap portion 200 may have a value of 30 or more and 40 or less. The relative magnetic permeability may be calculated from the magnetic permeability, which may be measured by the permeameter method, the ferromagnetic resonance method, and the hysteresis loop method. Other methods and/or tools appreciated by one of ordinary skill in the art, even if not described in the present disclosure, may also be used.

The gap portion 200 may be disposed in at least one of a first region R1 between the first coil 111 and the second coil 112, a second region R2 between the second coil 112 and the third coil 113, and a third region R3 between the third coil 113 and the fourth coil 114.

For example, the gap portion 200 may include a first gap portion 210, a second gap portion 220, and a third gap portion 230.

The first gap portion 210 may be disposed in the first region R1 between the first coil 111 and the second coil 112.

The second gap portion 220 may be disposed in the second region R2 between the second coil 112 and the third coil 113.

The third gap portion 230 may be disposed in the third region R3 between the third coil 113 and the fourth coil 114.

The first gap portion 210 may have a substantially plate-like shape. For example, the first gap portion 210 may include a first main surface 211, a second main surface 212, a first side surface 213, a second side surface 214, a third side surface 215, and a fourth side surface 216.

The first main surface 211 may face the first coil 111, and the second main surface 212 may face the second coil 112. The first main surface 211 and the second main surface 212 may be opposite each other in the length direction (L-axis direction).

The first side surface 213 and the second side surface 214 may be opposite each other in the width direction (W-axis direction), and the third side surface 215 and the fourth side surface 216 may be opposite each other in the thickness direction (T-axis direction).

The first side surface 213 may be flush with the third surface S3 of the body 100, and the second side surface 214 may be flush with the fourth surface S4 of the body 100.

The third side surface 215 may be flush with the fifth surface S5 of the body 100, and the fourth side surface 216 may be flush with the sixth surface S6 of the body 100.

The second gap portion 220 may have a substantially plate-like shape. For example, the second gap portion 220 may include a first main surface 221, a second main surface 222, a first side surface 223, a second side surface 224, a third side surface 225, and a fourth side surface 226.

The third gap portion 230 may have a substantially plate-like shape. For example, the third gap portion 230 may include a first main surface 231, a second main surface 232, a first side surface 233, a second side surface 234, a third side surface 235, and a fourth side surface 236.

The first gap portion 210 and the third gap portion 230 may have the same shape, while the second gap portion 220 may have a different shape from the first gap portion 210 and the third gap portion 230. As used herein, the terms “different shape” or “a shape different from another shape” may refer to an outline of the gap portion that is different from an outline of another gap portion.

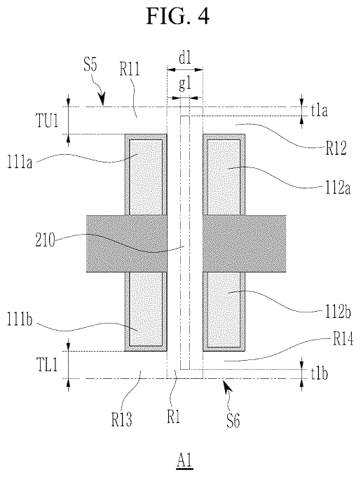

Referring to FIGS. 3 and 4, a first margin region R11 may be disposed between the fifth surface S5 of the body 100 and the first coil 111, and a second margin region R12 may be disposed between the fifth surface S5 and the second coil 112.

The first gap portion 210 may be spaced apart from the fifth surface S5 of the body 100. That is, there is a spacing t1a between the first gap portion 210 and the fifth surface S5 of the body 100.

The spacing t1a between the fifth surface S5 of the body 100 and the first gap portion 210 may be smaller than an average thickness TU1 of the first margin region R11 and the second margin region R12. For example, the spacing ta may be ⅓ of the average thickness TU1.

Herein, the average thickness of the first margin region R11 and the second margin region R12 may be measured based on a scanning electron microscope (SEM) image at 10,000× magnification of a cross-section taken along the length direction (L-axis direction)-thickness direction (T-axis direction) of the body. In the scanned image, the thickness of the first margin region may be measured at three equally spaced points along the length direction (L-axis direction) on the first coil, the thickness of the second margin region may be measured at three equally spaced points along the length direction (L-axis direction) on the second coil, and then an average value of the measured thicknesses may be taken. Other methods and/or tools appreciated by one of ordinary skill in the art, even if not described in the present disclosure, may also be used. The third margin region R13 may be disposed between the sixth surface S6 of the body 100 and the first coil 111, and the fourth margin region R14 may be disposed between the sixth surface S6 and the second coil 112.

The first gap portion 210 may be spaced apart from the sixth surface S6 of the body 100. That is, a spacing t1b between the first gap portion 210 and the sixth surface S6 of the body 100.

The spacing t1b between the sixth surface S6 of the body 100 and the first gap portion 210 may be smaller than an average thickness TL1 of the third margin region R13 and the fourth margin region R14. For example, the spacing t1b may be ⅓ of the average thickness TL1.

Herein, the average thickness of the third margin region R13 and the fourth margin region R14 may be measured based on a scanning electron microscope (SEM) image at 10,000× magnification of a cross-section taken along the length direction (L-axis direction)-thickness direction (T-axis direction) of the body. In the scanned image, the thickness of the third margin region may be measured at three equally spaced points along the length direction (L-axis direction) on the first coil, the thickness of the fourth margin region may be measured at three equally spaced points along the length direction (L-axis direction) on the second coil, and then an average value of the measured thicknesses may be taken. Other methods and/or tools appreciated by one of ordinary skill in the art, even if not described in the present disclosure, may also be used.

The first region R1 may have a first distance d1. The first distance d1 may be a distance between the first coil 111 and the second coil 112. The first distance d1 may be, e.g., 120 μm.

The first gap portion 210 may have a first width g1. The first width g1 may be greater than 24% and less than 42% of the first distance d1. For example, when the first distance d1 is 120 μm, the first width g1 may be greater than 30 μm and less than 50 μm.

If the first width g1 is less than or equal to 24% of the first distance d1 or if the first width g1 is greater than or equal to 42% of the first distance d1, the inductance deviation of the coils may become excessively large.

Herein, the first distance d1 and the first width g1 may each refer to an average value. The first distance d1 and the first width g1 may be measured based on a scanning electron microscope (SEM) image at 10,000× magnification of a cross-section taken along the length direction (L-axis direction)-thickness direction (T-axis direction) of the body. In the scanned image, the first distance may be measured at ten (10) equally spaced points in the thickness direction (T-axis direction) on the first coil (or second coil) and then an average value of the measured distances may be taken, and the first width may be measured at ten (10) equally spaced points in the thickness direction (T-axis direction) on the first gap portion and then an average value of the measured widths may be taken. Other methods and/or tools appreciated by one of ordinary skill in the art, even if not described in the present disclosure, may also be used.

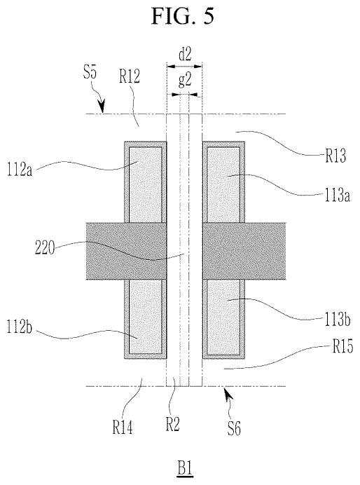

Referring to FIGS. 3 and 5, a second margin region R12 may be disposed between the fifth surface S5 of the body 100 and the second coil 112, and a third margin region R13 may be disposed between the fifth surface S5 and the third coil 113.

The second gap portion 220 may be flush with the fifth surface S5 of the body 100. That is, there is no spacing between the second gap portion 220 and the fifth surface S5 of the body 100.

A fourth margin region R14 may be disposed between the sixth surface S6 of the body 100 and the second coil 112, and a fifth margin region R15 may be disposed between the sixth surface S6 and the third coil 113.

The second gap portion 220 may be flush with the sixth surface S6 of the body 100. That is, there is no spacing between the second gap portion 220 and the sixth surface S6 of the body 100.

The second region R2 may have a second distance d2. The second distance d2 may be a distance between the second coil 112 and the third coil 113. The second distance d2 may be, e.g., 120 μm.

The second gap portion 220 may have a second width g2. The second width g2 may be greater than 24% and less than 42% of the second distance d2. For example, when the second distance d2 is 120 μm, the second width g2 may be greater than 30 μm and less than 50 μm.

If the second width g2 is less than or equal to 24% of the second distance d2 or if the second width g2 is greater than or equal to 42% of the second distance d2, the inductance deviation of the coils may become excessively large.

Herein, the second distance d2 and the second width g2 may each refer to an average value. The second distance d2 and the second width g2 may be measured based on a scanning electron microscope (SEM) image at 10,000× magnification of a cross-section taken along the length direction (L-axis direction)-thickness direction (T-axis direction) of the body. In the scanned image, the second distance may be measured at ten (10) equally spaced points in the thickness direction (T-axis direction) on the second coil (or third coil) and then an average value of the measured distances may be taken, and the second width may be measured at ten (10) equally spaced points in the thickness direction (T-axis direction) on the second gap portion and then an average value of the measured distances may be taken.

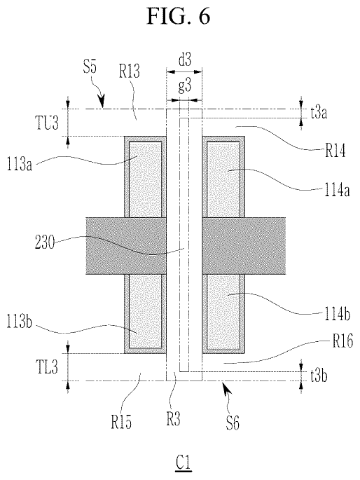

Referring to FIGS. 3 and 6, a third margin region R13 may be disposed between the fifth surface S5 of the body 100 and the third coil 113, and a fourth margin region R14 may be disposed between the fifth surface S5 and the fourth coil 114.

The third gap portion 230 may be spaced apart from the fifth surface S5 of the body 100. That is, there is a spacing t3a between the third gap portion 230 and the fifth surface S5 of the body 100.

The spacing t3a between the fifth surface S5 of the body 100 and the third gap portion 230 may be smaller than an average thickness TU3 of the third margin region R13 and the fourth margin region R14. For example, the spacing t3a may be ⅓ of the average thickness TU3.

Herein, the average thickness of the third margin region R13 and the fourth margin region R14 may be measured based on a scanning electron microscope (SEM) image at 10,000× magnification of a cross-section taken along the length direction (L-axis direction)-thickness direction (T-axis direction) of the body. In the scanned image, the thickness of the third margin region may be measured at three equally spaced points along the length direction (L-axis direction) on the third coil, the thickness of the fourth margin region may be measured at three equally spaced points in the length direction (L-axis direction) on the fourth coil, and then an average value of the measured thicknesses may be taken.

The fifth margin region R15 may be disposed between the sixth surface S6 of the body 100 and the third coil 113, and the sixth margin region R16 may be disposed between the sixth surface S6 and the fourth coil 114.

The third gap portion 230 may be spaced apart from the sixth surface S6 of the body 100. That is, a spacing t3b between the third gap portion 230 and the sixth surface S6 of the body 100.

The spacing t3b between the sixth surface S6 of the body 100 and the third gap portion 230 may be smaller than an average thickness TL3 of the fifth margin region R15 and the sixth margin region R16. For example, the spacing t3b may be ⅓ of the average thickness TL3.

Herein, the average thickness of the fifth margin region R15 and the sixth margin region R16 may be measured based on a scanning electron microscope (SEM) image at 10,000× magnification of a cross-section taken along the length direction (L-axis direction)-thickness direction (T-axis direction) of the body. In the scanned image, the thickness of the fifth margin region may be measured at three equally spaced points along the length direction (L-axis direction) on the third coil, the thickness of the sixth margin region may be measured at three equally spaced points in the length direction (L-axis direction) on the fourth coil, and an average value of the measured thicknesses may be taken. Other methods and/or tools appreciated by one of ordinary skill in the art, even if not described in the present disclosure, may also be used.

The third region R3 may have a third distance d3. The third distance d3 may be a distance between the third coil 113 and the fourth coil 114. The third distance d3 may be, e.g., 120 μm.

The third gap portion 230 may have a third width g3. The third width g3 may be greater than 24% and less than 42% of the third distance d3. For example, when the third distance d3 is 120 μm, the third width g3 may be greater than 30 μm and less than 50 μm.

If the third width g3 is less than or equal to 24% of the third distance d3 or if the third width g3 is greater than or equal to 42% of the third distance d3, an inductance deviation of the coils may become excessively large.

Herein, the third distance d3 and the third width g3 may each refer to an average value. The third distance d3 and the third width g3 may be measured based on a scanning electron microscope (SEM) image at 10,000× magnification of a cross-section of a length direction (L-axis direction)-thickness direction (T-axis direction) of the body. In the scanned image, the third distance may be measured at ten (10) equally spaced points along the thickness direction (T-axis direction) on the third coil (or fourth coil) and an average value of the measured distances may be taken, and the third width may be measured at ten (10) equally spaced points in the thickness direction (T-axis direction) on the third gap portion and then an average value of the measured widths may be taken.

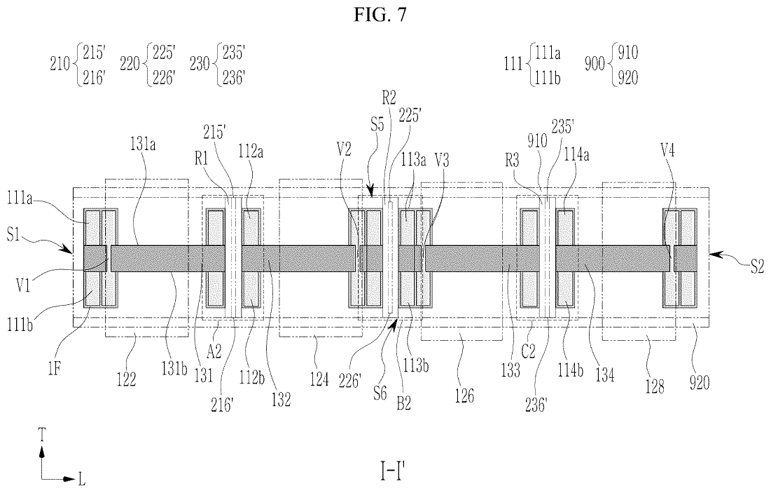

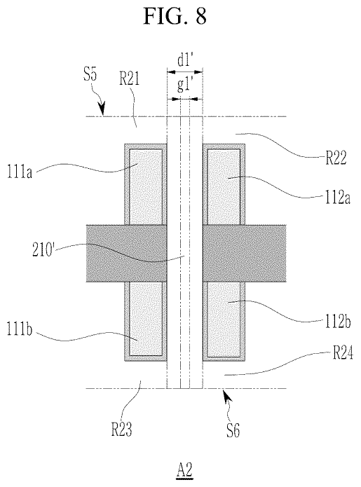

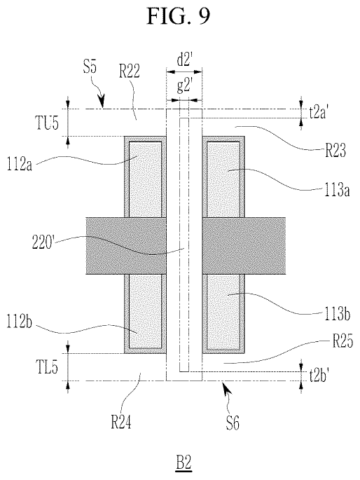

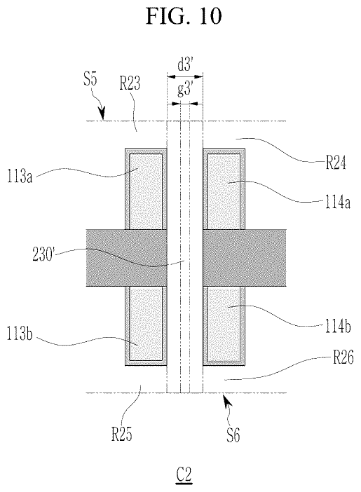

FIG. 7 illustrates a schematic cross-sectional view showing a coil electronic component according to another embodiment. FIG. 8 illustrates an enlarged view of a region A2 of FIG. 7, FIG. 9 illustrates an enlarged view of a region B2 of FIG. 7, and FIG. 10 illustrates an enlarged view of a region C2 of FIG. 7.

Referring to FIGS. 7 and 8, a first margin region R21 may be disposed between the fifth surface S5 of the body 100 and the first coil 111, and a second margin region R22 may be disposed between the fifth surface S5 and the second coil 112.

The first gap portion 210′ may be flush with the fifth surface S5 of the body 100.

The third margin region R23 may be disposed between the sixth surface S6 of the body 100 and the first coil 111, and the fourth margin region R24 may be disposed between the sixth surface S6 and the second coil 112.

The first gap portion 210′ may be flush with the sixth surface S6 of the body 100.

The first region R1 may have a first distance d1′. The first distance d1′ may be a distance between the first coil 111 and the second coil 112. The first distance d1′ may be, e.g., 120 μm.

The first gap portion 210 may have a first width g1′. The first width g1′ may be greater than 24% and less than 42% of the first distance d1′. For example, when the first distance d1′ is 120 μm, the first width g1′ may be greater than 30 μm and less than 50 μm.

If the first width g1′ is less than or equal to 24% of the first distance d1′ or if the first width g1′ is greater than or equal to 42% of the first distance d1′, the inductance deviation of the coils may become excessively large.

Herein, the first distance d1 and the first width g1′ may each refer to an average value. The first distance d1′ and the first width g1′ may be measured based on a scanning electron microscope (SEM) image at 10,000× magnification of a cross-section taken along the length direction (L-axis direction)-thickness direction (T-axis direction) of the body. In the scanned image, the first distance may be measured at ten (10) equally spaced points along the thickness direction (T-axis direction) on the first coil (or second coil) and then an average value of the measured distances may be taken, and the first width may be measured at ten (10) equally spaced points along the thickness direction (T-axis direction) on the first gap portion and then an average value of the measured widths may be taken.

Referring to FIGS. 7 and 9, a second margin region R22 may be disposed between the fifth surface S5 of the body 100 and the first coil 111, and a third margin region R23 may be disposed between the fifth surface S5 and the second coil 112.

The second gap portion 220′ may be spaced apart from the fifth surface S5 of the body 100.

The spacing t2a′ between the fifth surface S5 of the body 100 and the second gap portion 220′ may be smaller than an average thickness TU5 of the second margin region R22 and the third margin region R23. For example, the spacing t2a′ may be ⅓ of the average thickness TU5.

Herein, the average thickness of the second margin region R22 and the third margin region R23 may be measured based on a scanning electron microscope (SEM) image at 10,000× magnification of a cross-section taken along the length direction (L-axis direction)-thickness direction (T-axis direction) of the body. In the scanned image, the thickness of the second margin region may be measured at three equally spaced points along the length direction (L-axis direction) on the second coil, the thickness of the third margin region may be measured at three equally spaced points along the length direction (L-axis direction) on the third coil, and then an average value of the measured thicknesses may be taken. Other methods and/or tools appreciated by one of ordinary skill in the art, even if not described in the present disclosure, may also be used.

The fourth margin region R24 may be disposed between the sixth surface S6 of the body 100 and the first coil 111, and the fifth margin region R25 may be disposed between the sixth surface S6 and the second coil 112.

The second gap portion 220′ may be spaced apart from the sixth surface S6 of the body 100.

The spacing t2b′ between the sixth surface S6 of the body 100 and the second gap portion 220′ may be smaller than an average thickness TL5 of the fourth margin region R24 and the fifth margin region R25. For example, the spacing t2b′ may be ⅓ of the average thickness TL5.

The spacing between the fifth surface S5 or sixth surface S6 100 and each of the first gap portion 210, second gap portion 220, and third gap portion may be measured by SEM. Other methods and/or tools appreciated by one of ordinary skill in the art, even if not described in the present disclosure, may also be used.

Herein, the average thickness of the fourth margin region R24 and the fifth margin region R25 may be measured based on a scanning electron microscope (SEM) image at 10,000× magnification of a cross-section taken along the length direction (L-axis direction)-thickness direction (T-axis direction) of the body. In the scanned image, the thickness of the fourth margin region may be measured at three equally spaced points along the length direction (L-axis direction) on the second coil, the thickness of the fifth margin region may be measured at three equally spaced points along the length direction (L-axis direction) on the third coil, and then an average value of the measured thicknesses may be taken. Other methods and/or tools appreciated by one of ordinary skill in the art, even if not described in the present disclosure, may also be used.

The second region R2 may have a second distance d2′. The second distance d2′ may be a distance between the second coil 112 and the third coil 113. The second distance d2′ may be, e.g., 120 μm.

The second gap portion 220′ may have a second width g2′. The second width g2′ may be greater than 24% and less than 42% of the second distance d2′. For example, when the second distance d2′ is 120 μm, the second width g2′ may be greater than 30 μm and less than 50 μm.

If the second width g2 is less than or equal to 24% of the second distance d2′ or if the second width g2′ is greater than or equal to 42% of the second distance d2′, the inductance deviation of the coils may become excessively large. Herein, the second distance d2′ and the second width g2′ may each refer to an average value. The second distance d2′ and the second width g2′ may be measured based on a scanning electron microscope (SEM) image at 10,000× magnification of a cross-section taken along the length direction (L-axis direction)-thickness direction (T-axis direction) of the body. In the scanned image, the second distance may be measured at ten (10) equally spaced points along the thickness direction (T-axis direction) on the second coil (or third coil) and then an average value of the measured distances may be taken, and the second width may be measured at ten (10) equally spaced points along the thickness direction (T-axis direction) on the second gap portion and then an average value of the measured widths may be taken.

Referring to FIGS. 7 and 10, a third margin region R23 may be disposed between the fifth surface S5 of the body 100 and the first coil 111, and a fourth margin region R24 may be disposed between the fifth surface S5 and the second coil 112.

The third gap portion 230′ may be flush with the fifth surface S5 of the body 100.

The fifth margin region R25 may be disposed between the sixth surface S6 of the body 100 and the first coil 111, and the sixth margin region R26 may be disposed between the sixth surface S6 and the second coil 112.

The third gap portion 230′ may be flush with the sixth surface S6 of the body 100.

The third region R3 may have a third distance d3′. The third distance d3′ may be a distance between the first coil 111 and the second coil 112. The third distance d3′ may be, e.g., 120 μm.

The third gap portion 230′ may have a third width g3′. The third width g3′ may be greater than 24% and less than 42% of the third distance d3′. For example, when the third distance d3′ is 120 μm, the third width g3′ may be greater than 30 μm and less than 50 μm.

If the third width g3′ is less than or equal to 24% of the third distance d3′ or if the third width g3′ is greater than or equal to 42% of the third distance d3′, the inductance deviation of the coils may become excessively large.

Herein, the third distance d3′ and the third width g3′ may each refer to an average value. The third distance d3′ and the third width g3′ may be measured based on a scanning electron microscope (SEM) image at 10,000× magnification of a cross-section taken along the length direction (L-axis direction)-thickness direction (T-axis direction) of the body. In the scanned image, the third distance may be measured at ten (10) equally spaced points along the thickness direction (T-axis direction) on the third coil (or fourth coil) and then an average value of the measured distances may be taken, and the third width may be measured at ten (10) equally spaced points along the thickness direction (T-axis direction) on the third gap portion and then an average value of the measured widths may be taken.

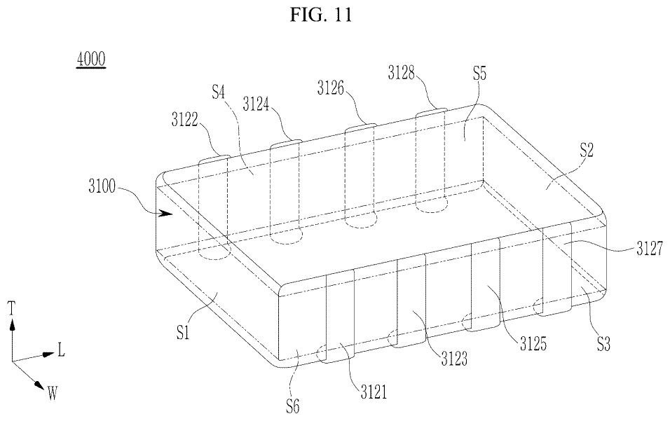

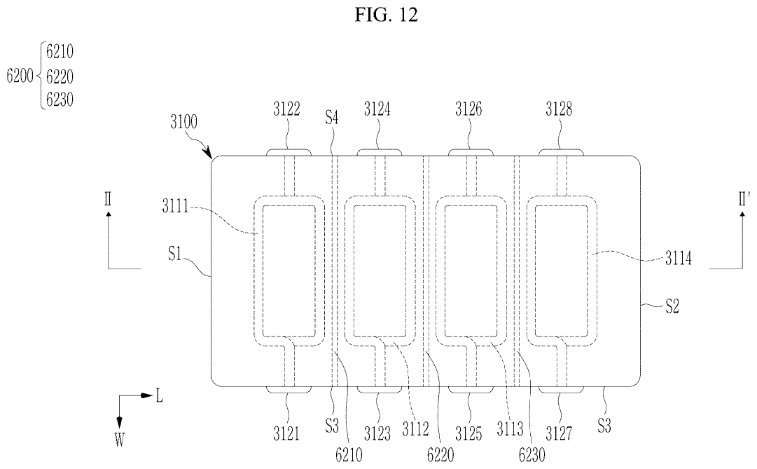

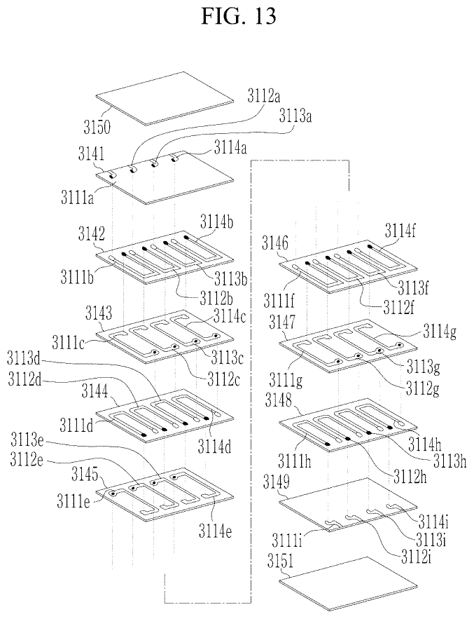

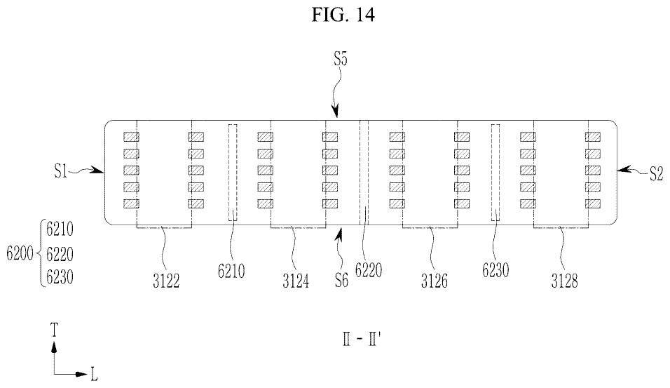

FIG. 11 illustrates a schematic perspective view showing a coil electronic component according to another embodiment, FIG. 12 illustrates a top plan view of FIG. 11, and FIG. 13 illustrates an exploded perspective view showing a body of the coil electronic component of FIG. 11. FIG. 14 illustrates a schematic cross-sectional view taken along line II-II′ of FIG. 12.

Referring to FIGS. 11, 12, and 14, a coil electronic component 4000 may include a body 3100, first to eighth external electrodes 3121, 3122, 3123, 3124, 3125, 3126, 3127, and 3128 disposed on an outer surface of the body 3100, a plurality of coils 3111, 3112, 3113, and 3114 embedded in the body 3100, and a gap portion 6200.

The first coil 3111, the second coil 3112, the third coil 3113, and the fourth coil 3114 may be embedded in the body 3100. The winding axes of the first coil 3111, the second coil 3112, the third coil 3113, and the fourth coil 3114 may be parallel to the thickness direction (T-axis direction) of the body 3100.

The gap portion 6200 may include a first gap portion 6210, a second gap portion 6220, and a third gap portion 6230.

The first gap portion 6210 may be disposed between the first coil 3111 and the second coil 3112, the second gap portion 6220 may be disposed between the second coil 3112 and the third coil 3113, and the third gap portion 6230 may be disposed between the third coil 3113 and the fourth coil 3114.

Referring to FIG. 14, the first gap portion 6210 and the third gap portion 6230 may have the same shape, and the second gap portion 6220 may have a different shape from the first gap portion 6210 and the third gap portion 6230.

For example, the first gap portion 6210 may be spaced apart from each of the fifth surface S5 and the sixth surface S6 of the body 3100, and the third gap portion 6230 may be spaced apart from each of the fifth surface S5 and the sixth surface S6 of the body 3100. The second gap portion 6220 may be flush with each of the fifth surface S5 and the sixth surface S6 of the body 3100.

Referring to FIG. 13, the body 3100 may be a laminate made by stacking a plurality of magnetic sheets 3141, 3142, 3143, 3144, 3145, 3146, 3147, 3148, and 3149 on which conductor patterns 3111a to 3111i, 3112a to 3112i, 3113a to 3113i, and 3114a to 3114i comprising portions of the first to fourth coils 3111, 3112, 3113, and 3114 are disposed and a plurality of magnetic sheets 3150 and 3151 on which no conductor patterns are disposed in the thickness direction (T-axis direction).

A plurality of substantially J-shaped conductor patterns 3111a, 3112a, 3113a, and 3114a may be formed on the magnetic sheet 3141. One end of each of the conductor patterns 3111a, 3112a, 3113a, and 3114a may be drawn out from the edge of the magnetic sheet 3141 so as to be exposed from the fourth surface S4 of the body 3100.

A plurality of conductor patterns 3111b, 3112b, 3113b, and 3114b electrically connected to the respective conductor patterns 3111a, 3112a, 3113a, and 3114a may be formed on the magnetic sheet 3142. The conductor patterns 3111b, 3112b, 3113b, and 3114b may correspond to nearly ¾ of a turn of the first to fourth coils 3111, 3112, 3113, and 3114, and may be in a substantially U-shape.

A plurality of conductor patterns 3111c, 3112c, 3113c, and 3114c electrically connected to the respective conductor patterns 3111b, 3112b, 3113b, and 3114b may be formed on the magnetic sheet 3143. The conductor patterns 3111c, 3112c, 3113c, and 3114c may correspond to nearly ¾ of a turn of the first to fourth coils 3111, 3112, 3113, and 3114, and may be in a substantially C-shape.

A plurality of conductor patterns 3111d, 3112d, 3113d, and 3114d electrically connected to the respective conductor patterns 3111c, 3112c, 3113c, and 3114c may be formed on the magnetic sheet 3144. The conductor patterns 3111d, 3112d, 3113d, and 3114d may correspond to nearly ¾ of a turn of the first to fourth coils 3111, 3112, 3113, and 3114, and may be in a substantially U-shape.

A plurality of conductor patterns 3111e, 3112e, 3113e, and 3114e electrically connected to the respective conductor patterns 3111d, 3112d, 3113d, and 3114d may be formed on the magnetic sheet 3145. The conductor patterns 3111e, 3112e, 3113e, and 3114e may correspond to nearly ¾ of a turn of the first to fourth coils 3111, 3112, 3113, and 3114, and may be in an approximately C-shape.

A plurality of conductor patterns 3111f, 3112f, 3113f, and 3114f electrically connected to the respective conductor patterns 3111e, 3112e, 3113e, and 3114e may be formed on the magnetic sheet 3146. The conductor patterns 3111f, 3112f, 3113f, and 3114f may have the same structure as the conductor patterns 3111b, 3112b, 3113b, and 3114b described above.

A plurality of conductor patterns 3111g, 3112g, 3113g, and 3114g electrically connected to the respective conductor patterns 3111f, 3112f, 3113f, and 3114f may be formed on the magnetic sheet 3147. The conductor patterns 3111g, 3112g, 3113g, and 3114g may have the same structure as the conductor patterns 3111c, 3112c, 3113c, and 3114c described above.

A plurality of conductor patterns 3111h, 3112h, 3113h, and 3114h electrically connected to the respective conductor patterns 3111g, 3112g, 3113g, and 3114g may be formed on the magnetic sheet 3148. The conductor patterns 3111h, 3112h, 3113h, and 3114h may have the same structure as the conductor patterns 3111d, 3112d, 3113d, and 3114d described above.

A plurality of substantially J-shaped conductor patterns 3111i, 3112i, 3113i, and 3114i electrically connected to the respective conductor patterns 3111h, 3112h, 3113h, and 3114h may be formed on the magnetic sheet 3149. One end of each of the conductor patterns 3111i, 3112i, 3113i, and 3114i may be drawn out from the edge of the magnetic sheet 3149 so as to be exposed from the third surface S3 of the body 3100. Furthermore, electrical connections between conductor patterns on different magnetic sheets may be made via through-holes (not shown) formed in the magnetic sheets.

By stacking the plurality of magnetic sheets 3141, 3142, 3143, 3144, 3145, 3146, 3147, 3148, and 3149 on which the conductor patterns 3111a to 3111i, 3112a to 3112i, 3113a to 3113i, and 3114a to 3114i are disposed, a body 3100 including first to fourth coils 3111, 3112, 3113, and 3114 may be formed. A gap portion 6200 may be formed by cutting the body between two adjacent coils of any of the first to fourth coils 3111, 3112, 3113, and 3114, forming a groove, filling the groove with glass, and then disposing a magnetic material thereon. However, the present embodiment is not limited thereto, and the gap portion may be formed in various other methods.

The magnetic sheet 3150 on which no conductor pattern is disposed may be stacked on the magnetic sheet 3141. The magnetic sheet 3150 may protect the conductor patterns 3111a, 3112a, 3113a, and 3114a on the magnetic sheet 3141. Furthermore, another magnetic sheet 3151 on which no conductor pattern is disposed may be disposed under the magnetic sheet 3149.

The number of magnetic sheets described above is by way of example only, and the present embodiment is not limited thereto.

The remaining components, except for the above, are identical to the components of the coil electronic component shown in FIG. 1, so a repeated description thereof will be omitted.

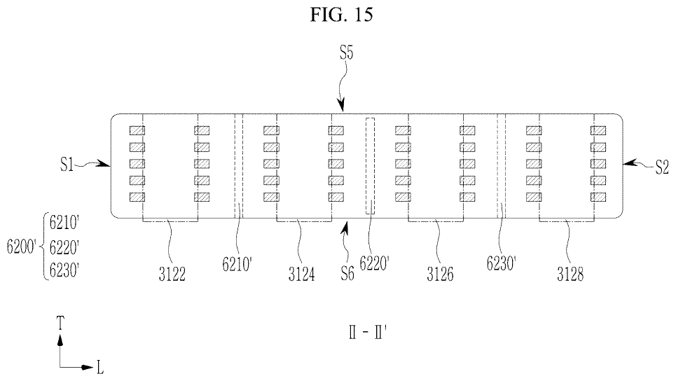

FIG. 15 illustrates a schematic cross-sectional view showing a coil electronic component according to another embodiment.

Referring to FIG. 15, the gap portion 6200′ may include a first gap portion 6210′, a second gap portion 6220′, and a third gap portion 6230′. The first gap portion 6210′ may be flush with each of the fifth surface S5 and the sixth surface S6 of the body 3100, and the third gap portion 6230′ may be flush with each of the fifth surface S5 and the sixth surface S6 of the body 3100. The second gap portion 6220′ may be spaced apart from the fifth surface S5 and the sixth surface S6 of the body 3100.

The remaining components, except for the above, are identical to the components of the coil electronic component shown in FIG. 11, so a repeated description thereof will be omitted.

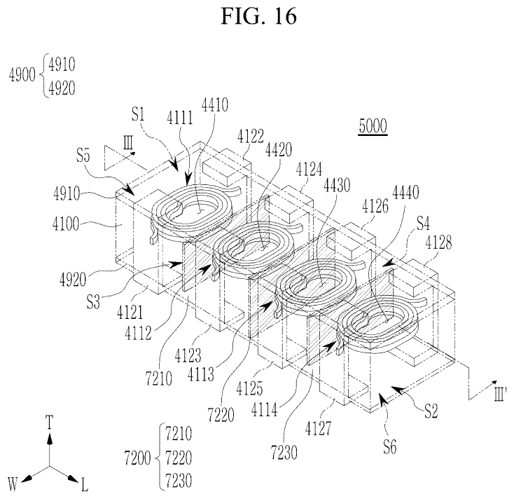

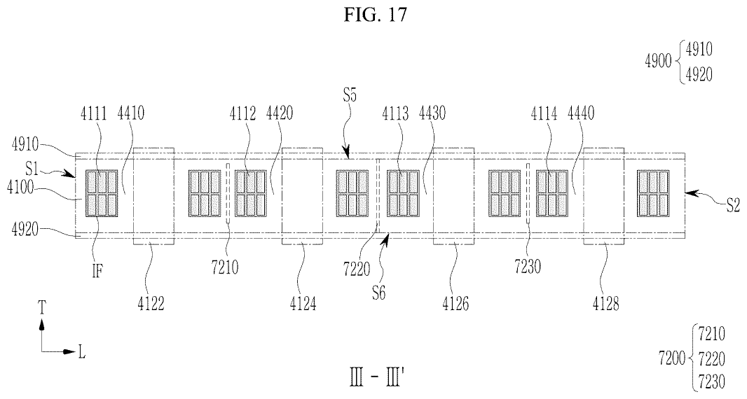

FIG. 16 illustrates a schematic perspective view showing a coil electronic component according to another embodiment, and FIG. 17 illustrates a schematic cross-sectional view taken along line III-III′ of FIG. 16.

Referring to FIGS. 16 and 17, a coil electronic component 5000 may include a body 4100, first to eighth external electrodes 4121, 4122, 4123, 4124, 4125, 4126, 4127, and 4128 disposed on an outer surface of the body 4100, a plurality of coils 4111, 4112, 4113, and 4114 embedded in the body 4100, and a gap portion 7200.

The first coil 4111, the second coil 4112, the third coil 4113, and the fourth coil 4114 may be embedded in the body 4100. The body 4100 may include a first core 4410 penetrating the first coil 4111, a second core 4420 penetrating the second coil 4112, a third core 4430 penetrating the third coil 4413, and a fourth core 4440 penetrating the fourth coil 4414.

The first coil 4111 may include at least one turn of conductive wire. An insulating layer IF may be disposed on a surface of the first coil 4111.

The second coil 4112, the third coil 4113, and the fourth coil 4114 differ from the first coil 4111 only in their locations, so redundant descriptions thereof will be omitted.

The gap portion 7200 may include a first gap portion 7210, a second gap portion 7220, and a third gap portion 7230.

The first gap portion 7210 may be disposed between the first coil 4111 and the second coil 4112, the second gap portion 7220 may be disposed between the second coil 4112 and the third coil 4113, and the third gap portion 7230 may be disposed between the third coil 4113 and the fourth coil 4114.

The first gap portion 7210 and the third gap portion 7230 may have the same shape, and the second gap portion 7220 may have a different shape from the first gap portion 7210 and the third gap portion 7230. For example, the first gap portion 7210 may be spaced apart from each of the fifth surface S5 and the sixth surface S6 of the body 4100, and the third gap portion 7230 may be spaced apart from each of the fifth surface S5 and the sixth surface S6 of the body 4100. The second gap portion 7220 may be flush with each of the fifth surface S5 and the sixth surface S6 of the body 4100.

Meanwhile, a surface insulating layer 4900 may be disposed on the fifth surface S5 and the sixth surface S6 of the body 4100. The surface insulating layer 4900 may include a first insulating layer 4910 and a second insulating layer 4920. The first insulating layer 4910 may be disposed on the fifth surface S5 of the body 4100, and the second insulating layer 4920 may be disposed on the sixth surface S6 of the body 4100.

The remaining components, except for the above, are identical to the components of the coil electronic component shown in FIG. 1, so a repeated description thereof will be omitted.

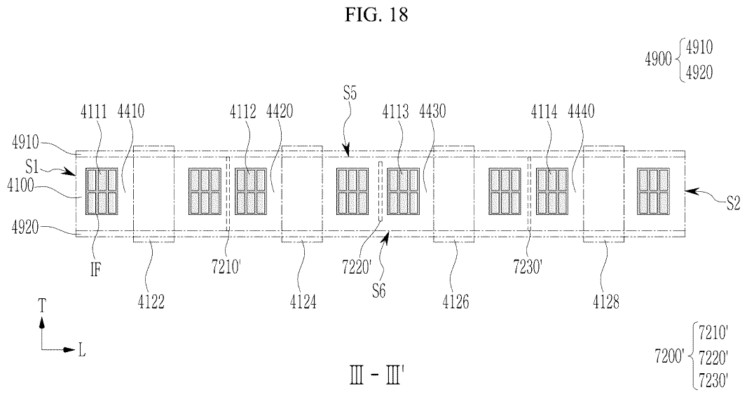

FIG. 18 illustrates a schematic cross-sectional view showing a coil electronic component according to another embodiment.

Referring to FIG. 18, a gap portion 7200′ may include a first gap portion 7210′, a second gap portion 7220′, and a third gap portion 7230′. The first gap portion 7210′ may be flush with each of the fifth surface S5 and the sixth surface S6 of the body 4100, and the third gap portion 7230′ may be flush with each of the fifth surface S5 and the sixth surface S6 of the body 4100. The second gap portion 7220′ may be spaced apart from the fifth surface S5 and the sixth surface S6 of the body 4100.

The remaining components, except for the above, are identical to the components of the coil electronic component shown in FIG. 16, so a repeated description thereof will be omitted.

### Preparation Example: Manufacture of Coil Electronic Components

### Example 1

A coil electronic component was manufactured with four coils spaced apart and embedded in a body and a gap portion disposed between the coils. The relative magnetic permeability of the body was 12, and the relative magnetic permeability of the gap portion was 36.

A thickness of the body was 1000 μm.

A thickness of a support member was 20 μm, and thicknesses of the first coil, second coil, and third coil measured from a surface of the support member were 170 μm each.

Thicknesses of a first margin region, a second margin region, and a third margin region were 320 μm each, and thicknesses of a fourth margin region, a fifth margin region, and a sixth margin region were 320 μm each.

A first distance of a first region was 120 μm, a second distance of a second region was 120 μm, and a third distance of a third region was 120 μm.

A distance between a fifth surface of the body and the first gap portion was 107 μm, the fifth surface of the body was flush with the second gap portion, and a distance between the fifth surface of the body and the third gap portion was 107 μm.

A first width of the first gap portion was 35 μm, a second width of the second gap portion was 35 μm, and a third width of the third gap portion was 35 μm.

### Example 2

A first width of the first gap portion was 40 μm, a second width of the second gap portion was 40 μm, and a third width of the third gap portion was 40 μm. Except for the above, Example 2 was identical to Example 1.

### Example 3

A first width of the first gap portion was 45 μm, a second width of the second gap portion was 45 μm, and a third width of the third gap portion was 45 μm. Except for the above, Example 3 was identical to Example 1.

### Comparative Example 1

A first width of the first gap portion was 10 μm, a second width of the second gap portion was 10 μm, and a third width of the third gap portion was 10 μm. Except for the above, Comparative Example 1 was identical to Example 1.

### Comparative Example 2

A first width of the first gap portion was 20 μm, a second width of the second gap portion was 20 μm, and a third width of the third gap portion was 20 μm. Except for the above, Comparative Example 2 was identical to Example 1.

### Comparative Example 3

A first width of the first gap portion was 30 μm, a second width of the second gap portion was 30 μm, and a third width of the third gap portion was 30 μm. Except for the above, Comparative Example 3 was identical to Example 1.

### Comparative Example 4

A first width of the first gap portion was 50 μm, a second width of the second gap portion was 50 μm, and a third width of the third gap portion was 50 μm. Except for the above, Comparative Example 4 was identical to Example 1.

### Comparative Example 5

A first width of the first gap portion was 60 μm, a second width of the second gap portion was 60 μm, and a third width of the third gap portion was 60 μm. Except for the above, Comparative Example 5 was identical to Example 1.

### Comparative Example 6

The fifth surface of the body was flush with the first gap portion, the fifth surface of the body was flush with the second gap portion, and the fifth surface of the body was flush with the third gap portion. Except for the above, Comparative Example 6 was identical to Example 2.

### Comparative Example 7

A distance between the fifth surface of the body and the first gap portion was 213 μm, a distance between the fifth surface of the body and the second gap portion was 213 μm, and a distance between the fifth surface of the body and the third gap portion was 213 μm. Except for the above, Comparative Example 7 was identical to Example 2.

### Comparative Example 8

A distance between the fifth surface of the body and the first gap portion was 320 μm, a distance between the fifth surface of the body and the second gap portion was 320 μm, and a distance between the fifth surface of the body and the third gap portion was 320 μm. Except for the above, Comparative Example 8 was identical to Example 2.

### Example 4

The fifth surface of the body was flush with the first gap portion, a distance between the fifth surface of the body and the second gap portion was 107 μm, and the fifth surface of the body was flush with the third gap portion. Except for the above, Example 4 was identical to Example 1.

### Example 5

A first width of the first gap portion was 40 μm, a second width of the second gap portion was 40 μm, and a third width of the third gap portion was 40 μm. Except for the above, Example 5 was identical to Example 4.

### Example 6

A first width of the first gap portion was 45 μm, a second width of the second gap portion was 45 μm, and a third width of the third gap portion was 45 μm. Except for the above, Example 5 was identical to Example 4.

### Comparative Example 9

A first width of the first gap portion was 10 μm, a second width of the second gap portion was 10 μm, and a third width of the third gap portion was 10 μm. Except for the above, Comparative Example 9 was identical to Example 4.

### Comparative Example 10

A first width of the first gap portion was 20 μm, a second width of the second gap portion was 20 μm, and a third width of the third gap portion was 20 μm. Except for the above, Comparative Example 10 was identical to Example 4.

### Comparative Example 11

A first width of the first gap portion was 30 μm, a second width of the second gap portion was 30 μm, and a third width of the third gap portion was 30 μm. Except for the above, Comparative Example 11 was identical to Example 4.

### Comparative Example 12

A first width of the first gap portion was 50 μm, a second width of the second gap portion was 50 μm, and a third width of the third gap portion was 50 μm. Except for the above, Comparative Example 12 was identical to Example 4.

### Comparative Example 13

A first width of the first gap portion was 60 μm, a second width of the second gap portion was 60 μm, and a third width of the third gap portion was 60 μm. Except for the above, Comparative Example 13 was identical to Example 4.

### Comparative Example 14

The fifth surface of the body was flush with the first gap portion, the fifth surface of the body was flush with the second gap portion, and the fifth surface of the body was flush with the third gap portion. Except for the above, Comparative Example 14 was identical to Example 5.

### Comparative Example 15

A distance between the fifth surface of the body and the first gap portion was 213 μm, a distance between the fifth surface of the body and the second gap portion was 213 μm, and a distance between the fifth surface of the body and the third gap portion was 213 μm. Except for the above, Comparative Example 15 was identical to Example 5.

### Comparative Example 16

A distance between the fifth surface of the body and the first gap portion was 320 μm, a distance between the fifth surface of the body and the second gap portion was 320 μm, and a distance between the fifth surface of the body and the third gap portion was 320 μm. Except for the above, Comparative Example 16 was identical to Example 5.

### Experimental Example: Performance of Coil Electronic Components

After manufacturing fifty (50) pieces of each of coil electronic components each according to Examples 1 to 6 and Comparative Examples 1 to 16, the inductances of the first coil, the second coil, the third coil, and the fourth coil were measured, and the increase rates of the inductances of the second coil, the third coil, and the fourth coil were calculated based on the inductance of the first coil. The increase rate of the inductance of the second coil was calculated by subtracting the inductance of the first coil from the inductance of the second coil and by dividing the value obtained by the inductance of the first coil. The increase rates of the inductances of the third and fourth coils were calculated using the same method. When the increase rate of inductance was less than 3%, it was deemed “suitable,” and when the increase rate of inductance was more than or equal to 3%, it was deemed “unsuitable.”

Furthermore, when the inductance of each coil was less than 8.8 nH, it was deemed “suitable,” and when the inductance of each coil was more than or equal to 8.8 nH, it was deemed “unsuitable.”

The results are summarized in Table 1.

TABLE 1

| | | First coil | Second coil | Third coil | Fourth coil | |
|---|---|---|---|---|---|---|
| Comparative | Inductance (nH) | 7.986 | 8.387 | 8.481 | 8.100 | Unsuitable |
| Example 1 | Inductance | — | 5.02% | 6.19% | 1.42% | |
| | increase rate (%) | | | | | |
| Comparative | Inductance (nH) | 8.165 | 8.454 | 8.548 | 8.221 | Unsuitable |
| Example 2 | Inductance | — | 3.54% | 4.69% | 0.68% | |
| | increase rate (%) | | | | | |
| Comparative | Inductance (nH) | 8.286 | 8.482 | 8.572 | 8.345 | Unsuitable |
| Example 3 | Inductance | — | 2.36% | 3.44% | 0.71% | |
| | increase rate (%) | | | | | |
| Example 1 | Inductance (nH) | 8.348 | 8.491 | 8.582 | 8.407 | Suitable |
| | Inductance | — | 1.71% | 2.81% | 0.71% | |
| | increase rate (%) | | | | | |
| Example 2 | Inductance (nH) | 8.472 | 8.522 | 8.594 | 8.532 | Suitable |
| | Inductance | — | 0.60% | 1.44% | 0.70% | |
| | increase rate (%) | | | | | |
| Example 3 | Inductance (nH) | 8.499 | 8.619 | 8.645 | 8.598 | Suitable |
| | Inductance | — | 1.41% | 1.73% | 1.16% | |
| | increase rate (%) | | | | | |
| Comparative | Inductance (nH) | 8.561 | 8.808 | 8.826 | 8.727 | Unsuitable |
| Example 4 | Inductance | — | 2.88% | 3.09% | 1.93% | |
| | increase rate (%) | | | | | |
| Comparative | Inductance (nH) | 8.690 | 8.898 | 8.896 | 8.857 | Unsuitable |
| Example 5 | Inductance | — | 2.40% | 2.38% | 1.93% | |
| | increase rate (%) | | | | | |
| Comparative | Inductance (nH) | 8.897 | 8.997 | 9.085 | 8.965 | Unsuitable |
| Example 6 | Inductance | — | 1.12% | 2.12% | 0.77% | |
| | increase rate (%) | | | | | |
| Comparative | Inductance (nH) | 8.790 | 8.897 | 8.955 | 8.895 | Unsuitable |
| Example 7 | Inductance | — | 1.22% | 1.88% | 1.20% | |
| | increase rate (%) | | | | | |
| Comparative | Inductance (nH) | 8.126 | 8.460 | 8.598 | 8.301 | Unsuitable |
| Example 8 | Inductance | — | 4.11% | 5.82% | 2.16% | |
| | increase rate (%) | | | | | |
| Comparative | Inductance (nH) | 7.899 | 8.410 | 8.521 | 8.110 | Unsuitable |
| Example 9 | Inductance | — | 6.46% | 7.88% | 2.67% | |
| | increase rate (%) | | | | | |
| Comparative | Inductance (nH) | 8.195 | 8.464 | 8.605 | 8.238 | Unsuitable |
| Example 10 | Inductance | — | 3.28% | 5.00% | 0.52% | |
| | increase rate (%) | | | | | |
| Comparative | Inductance (nH) | 8.376 | 8.522 | 8.627 | 8.455 | Unsuitable |
| Example 11 | Inductance | — | 1.74% | 3.00% | 0.93% | |
| | increase rate (%) | | | | | |
| Example 4 | Inductance (nH) | 8.430 | 8.581 | 8.649 | 8.517 | Suitable |
| | Inductance | — | 1.79% | 2.60% | 1.04% | |
| | increase rate (%) | | | | | |
| Example 5 | Inductance (nH) | 8.491 | 8.612 | 8.650 | 8.542 | Suitable |
| | Inductance | — | 1.43% | 1.88% | 0.59% | |
| | increase rate (%) | | | | | |
| Example 6 | Inductance (nH) | 8.502 | 8.638 | 8.665 | 8.608 | Suitable |
| | Inductance | — | 1.60% | 1.92% | 1.24% | |
| | increase rate (%) | | | | | |
| Comparative | Inductance (nH) | 8.602 | 8.818 | 8.836 | 8.797 | Unsuitable |
| Example 12 | Inductance | — | 2.50% | 2.71% | 2.26% | |
| | increase rate (%) | | | | | |
| Comparative | Inductance (nH) | 8.700 | 8.933 | 8.959 | 8.927 | Unsuitable |
| Example 13 | Inductance | — | 2.68% | 2.98% | 2.62% | |
| | increase rate (%) | | | | | |
| Comparative | Inductance (nH) | 8.897 | 8.997 | 9.085 | 8.965 | Unsuitable |
| Example 14 | Inductance | — | 1.12% | 2.12% | 0.77% | |
| | increase rate (%) | | | | | |
| Comparative | Inductance (nH) | 8.790 | 8.897 | 8.955 | 8.895 | Unsuitable |
| Example 15 | Inductance | — | 1.22% | 1.88% | 1.20% | |
| | increase rate (%) | | | | | |
| Comparative | Inductance (nH) | 8.126 | 8.460 | 8.598 | 8.301 | Unsuitable |
| Example 16 | Inductance | — | 4.11% | 5.82% | 2.16% | |
| | increase rate (%) | | | | | |

Referring to Table 1, the inductance increase rates of the second coil, the third coil, and the fourth coil of the coil electronic component according to Examples 1 to 6 were less than 3%. In the coil electronic components according to Comparative Examples 1 to 3, 8 to 11, and 15 to 16, there were cases where the inductance increase rates of the second coil and the third coil was 3% or more, and in the coil electronic components according to Comparative Examples 4 to 7 and 12 to 15, there were cases where the inductance of the second coil and the third coil exceeded 8.8 nH. In the coil electronic components according to Examples, the deviations between the inductances of the first and fourth coils and the inductances of the second and third coils were relatively small, whereas in the coil electronic components according to Comparative Examples, the deviations between the inductances of the first and fourth coils and the inductances of the second and third coils was relatively large, or the inductances of the second and third coils were relatively large. Because the gap portions of the coil electronic components according to Comparative Examples have the same shape, the inductance of the second and third coils appears to have increased further due to the interference of the crossing magnetic fluxes between the different coils.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. A coil electronic component comprising:
a body including a magnetic material;
three or more coils embedded in the body, the three or more coils include a first coil, a second coil, and a third coil;
a plurality of external electrodes disposed outside the body and connected to the three or more coils; and
a plurality of gap portions including a first gap portion disposed between the first coil and the second coil, and a second gap portion disposed between the second coil and the third coil, the plurality of gap portions having a magnetic permeability different from a magnetic permeability of the body,
wherein the first gap portion has a shape different from a shape of the second gap portion.

2. The coil electronic component of claim 1, wherein
the three or more coils further include a fourth coil, where the first coil, the second coil, the third coil, and the fourth coil are spaced apart from each other in a first direction,
the plurality of gap portions further include a third gap portion, where the first gap portion is disposed in a first region between the first coil and the second coil, the second gap portion is disposed in a second region between the second coil and the third coil, and the third gap portion is disposed in a third region between the third coil and the fourth coil, and
the third gap portion has a shape that is different from (i) the shape of the first gap portion or (i) the shape of the second gap portion.

3. The coil electronic component of claim 2, wherein
the first gap portion and the third gap portion have the same shape, and the second gap portion has a shape different from the same shape.

4. The coil electronic component of claim 3, wherein
in a second direction intersecting the first direction, both the first gap portion and the third gap portion are spaced apart from an outer surface of the body.

5. The coil electronic component of claim 4, further comprising
in the second direction, a first margin region between the outer surface of the body and the first coil, a second margin region between the outer surface of the body and the second coil, a third margin region between the outer surface of the body and the third coil, and a fourth margin region between the outer surface of the body and the fourth coil, and
wherein a distance between the outer surface of the body and the first gap portion is ⅓ or less, excluding 0, of an average thickness of the first margin region and the second margin region, and
a distance between the outer surface of the body and the third gap portion is ⅓ or less, excluding 0, of an average thickness of the third margin region and the fourth margin region.

6. The coil electronic component of claim 4, wherein
in the second direction, the second gap portion includes a portion flush with the outer surface of the body.

7. The coil electronic component of claim 3, wherein
in a second direction intersecting the first direction, the first gap portion and the third gap portion each includes a portion flush with an outer surface of the body.

8. The coil electronic component of claim 7, wherein
in the second direction, the second gap portion is spaced apart from the outer surface of the body.

9. The coil electronic component of claim 8, further comprising:
in the second direction, a first margin region between the outer surface of the body and the first coil, a second margin region between the outer surface of the body and the second coil, a third margin region between the outer surface of the body and the third coil, and a fourth margin region between the outer surface of the body and the fourth coil, and
wherein a distance between the outer surface of the body and the second gap portion is ⅓ or less, excluding 0, of an average thickness of the second margin region and the third margin region.

10. The coil electronic component of claim 2, wherein
the first region, the second region, and the third region have a first distance, a second distance, and a third distance, respectively, in the first direction,
the first gap portion, the second gap portion, and the third gap portion have a first width, a second width and a third width, respectively, in the first direction,
the first width is greater than 24% and less than 42% of the first distance,
the second width is greater than 24% and less than 42% of the second distance, and
the third width is greater than 24% and less than 42% of the third distance.

11. The coil electronic component of claim 2, further comprising:
a first support member, a second support member, a third support member, and a fourth support member embedded in the body and spaced apart from each other,
wherein
the first coil is disposed on the first support member,
the second coil is disposed on the second support member,
the third coil is disposed on the third support member, and
the fourth coil is disposed on the fourth support member.

12. The coil electronic component of claim 11, further comprising:
a first via penetrating the first support member,
a second via penetrating the second support member,
a third via penetrating the third support member, and
a fourth via penetrating the fourth support member,
wherein
the first coil includes a first coil pattern and a second coil pattern, the first coil pattern and the second coil pattern are disposed on a first surface and a second surface of the first support member, respectively, and connected to each other through the first via,
the second coil includes a third coil pattern and a fourth coil pattern, the third coil pattern and the fourth coil pattern are disposed on a first surface and a second surface of the second support member, respectively, and connected to each other through the second via,
the third coil includes a fifth coil pattern and a sixth coil pattern, the fifth coil pattern and the sixth coil pattern are disposed on a first surface and a second surface of the third support member, respectively, and connected to each other through the third via, and
the fourth coil includes a seventh coil pattern and a eighth coil pattern, the seventh coil pattern and the eighth coil pattern are disposed on a first surface and a second surface of the fourth support member, respectively, and connected to each other through the fourth via.

13. The coil electronic component of claim 2, wherein
the body includes a laminate that includes a stack of a plurality of magnetic sheets, and
the first coil, the second coil, the third coil, and the fourth coil each includes a plurality of conductor patterns disposed on each magnetic sheet among the plurality of magnetic sheets and connected to each other.

14. The coil electronic component of claim 2, wherein
each of the first coil, the second coil, the third coil, and the fourth coil includes at least one turn of a conductive wire.

15. The coil electronic component of claim 14, wherein
the body includes a first core penetrating the first coil, a second core penetrating the second coil, a third core penetrating the third coil, and a fourth core penetrating the fourth coil.

16. The coil electronic component of claim 14, further comprising
an insulating layer disposed on a surface of the conductive wire.

17. The coil electronic component of claim 2, wherein
a relative magnetic permeability of each of the first gap portion, the second gap portion, and the third gap portion is 30 or more and 40 or less.

18. The coil electronic component of claim 1, wherein
the first gap portion is spaced apart from the second gap portion in a first direction, and
in a second direction intersecting the first direction, the first gap portion is spaced apart from an outer surface of the body, and the second gap portion includes a portion flush with the outer surface of the body.

19. The coil electronic component of claim 18, wherein
the first gap portion is disposed in a first region between the first coil and the second coil,
the second gap portion is disposed in a second region between the second coil and the third coil,
the first region and the second region have a first distance and a second distance, respectively, in the first direction,
the first gap portion and, the second gap portion have a first width and a second width, respectively, in the first direction,
the first width is greater than 24% and less than 42% of the first distance, and
the second width is greater than 24% and less than 42% of the second distance.

20. The coil electronic component of claim 1, wherein
a relative magnetic permeability of each of the first gap portion and the second gap portion is 30 or more and 40 or less.
